(19) United States
(12) Patent Application Publication
(10) Pub. No.: US 2017/0086388 A1
(43) Pub. Date: Mar. 30, 2017

(54) Foldable Hinged Trellis Device and Fabrication Method

(71) Applicant: Tommy M. Hess, Joliet, IL (US)

(72) Inventor: Tommy M. Hess, Joliet, IL (US)

(21) Appl. No.: 15/155,640

(22) Filed: May 16, 2016

Related U.S. Application Data
(60) Provisional application No. 62/179,703, filed on May 16, 2015.

(51) Int. Cl. A01G 9/12; B29C 65/00; B29C 65/56; B29C 33/40; B29C 33/38

(52) U.S. Cl. CPC A01G 9/12; B29C 33/405; B29C 33/3842; B29C 65/562; B29C 66/73921; B29K 2023/06; B29K 2821/00; B29L 2031/772

(57) ABSTRACT

A foldable trellis device in accordance with the present invention includes a predetermined trellis configuration having first and second symmetrical portions with substantially similar dimensions and design features. The foldable trellis device further includes pivoting connecting elements to pivotally connect the two portions to allow the two portions to “close” such that front surfaces of respective first and second portions become engaged, or to allow the first and second portions to manually positioned to vertically resist gusting winds. To increase the stability of the foldable trellis device when wind gusts are relatively strong and from varying directions, a stabilizing member is pivotally connected to the first and second portions to form a wind resistant configuration when taking a top elevation view of the foldable trellis device.

This Utility Application is based on Provisional Application No. 62/179,703, filed on May 16, 2015.

### BACKGROUND OF THE INVENTION

1. Field of the Invention

This invention relates to a foldable hinged trellis device, and more particularly, to a foldable, wind resistant trellis device capable of providing support for a plant or vegetation irrespective of wind speed and wind direction.

2. Background of the Prior Art

Prior art trellis devices are well known and have a myriad of uses including, but not limited to supporting and promoting the growth of flowering plants, such as rose bushes; and also are used for providing a relatively simple configuration relative to a season, such as a Christmas Tree, for supporting a string of lights that, when lit at night time, present an outline of the Christmas Tree in a yard or on a rooftop.

The problem with prior art trellis devices is that they are fabricated from relatively rigid, heavy and expensive material when the trellis supports a relatively heavy object or when the trellis device is exposed to relatively high velocity wind gusts. Further, prior art trellis device fabrication methods cannot construct a relatively complex configuration without a corresponding relatively expensive construction cost. Also, a prior are trellis device configured for use during a special “season” of the year, cannot be folded and placed in storage for reuse when the season of the year comes again.

A need exists for a lightweight, relatively sturdy, wind resistant, inexpensive trellis device having a method of fabrication that provides a myriad of configurations for the ultimate use of the trellis for a predetermined season for time period, and after the completion of the time period, the trellis device is relatively easy to fold in half and be stored until reused.

### SUMMARY OF THE INVENTION

It is an object of the present invention to overcome many of the disadvantages associated with prior art trellis devices for outdoor use. A principal object of the present invention is to provide a relatively light weight and sturdy trellis device capable of withstanding relatively high velocity winds. A feature of the trellis device is a pair of substantially identical and symmetrical “half” portions that are fabricated from a polyethylene or substantially equivalent material, the half portions being pivotally and detachably joined together via a central rod cooperating with hinges or channels secured to edge portions of each of the half portions to form a predetermined configuration. The half portions can be connected together and orientated to form a common planar surface, or can be angularly joined to form an angle between ninety and one hundred and eighty degrees.

Another feature of the trellis device is at least two relatively long anchor rods (one for each half portion), each having an upper end secured to a cooperating half portion of the trellis device, and each anchor rod having a “pointed” lower end for promoting insertion of the anchor rods into a ground portion. Yet another feature is at least two anchoring clamps that are substantially identical to the two anchor rods with the exception the anchoring clams are relatively smaller in length than the anchor rods. Each anchoring clamp secures a respective bottom portion of each half portion of the trellis to a ground portion or a mounting bar.

An advantage of the trellis device is that the two half portions can be folded and secured together for storage until the trellis device is to be reused. Another advantage of the trellis device is that the lightweight polyethylene material and the relatively long anchor rods cooperate to maintain the trellis device in a substantially vertical position irrespective of wind speed and direction. Yet another advantage of the trellis device is that the pointed lower ends of the anchor rods can be replaced with threaded ends to promote the rotational insertion of the lower ends of each rod into a threaded orifice of a mounting bar for the trellis device, thereby enabling the device to be mounted on a surface (such as a roof top) via the mounting bar by securing the mounting bar to the respective surface by means that do not damage the respective surface.

Another object of the present invention is to provide a trellis device having three substantially identical and symmetrical portions that are radially separated such that there is substantially about 120 degrees radially separating adjacent symmetrical portions, resulting in a relatively “Y” configuration when taking a top view of the assembled trellis device. A feature of the device is a central rod pivotally and detachably joining cooperating edge portions of each of the three symmetrical portions via receiving channels connected to corresponding edge portions. Another feature of the device are anchor rods having hooked upper ends connected to cooperating portions of each of the three symmetrical portions, the anchor rods having pointed or threaded lower ends that secure a bottom portion of each of the symmetrical portions to a ground portion or a mounting bar secured to a roof portion of a house. Yet another feature of the device is an anchor clamp securing a respective bottom portion of each of the three symmetrical portions of the trellis to a ground portion or a mounting bar.

Briefly, the invention provides a foldable hinged trellis device that includes a predetermined trellis configuration having at least two half portions; pivotally joining cooperating edge portions of each of the two half portions; and maintaining a selected vertical position of each of the two half portions after pivotally joining together the cooperating edge portions of the two half portions, resulting in the selected position of the two half portions being maintained irrespective of wind speed and wind direction.

Further, the invention provides a foldable hinged trellis device that includes a predetermined trellis configuration having at least three substantially similarly configured portions; pivotally joining cooperating edge portions of each of the three substantially similarly configured portions; and maintaining a selected vertical position for each of the three configured portions after pivotally joining together the cooperating edge portions of the three configured portions, resulting in the selected vertical position being maintained irrespective of wind speed and wind direction.

Also, the invention provides a method for fabricating a wind resistant trellis. The method includes the steps of:

selecting a configuration for the wind resistant trellis;

programming the selected configuration into a computer;

directing the programmed computer to cut, to a preselected scale, the selected configuration from a relatively rigid polymer;

fabricating a rubber mold from the polymer configuration;

inserting polyethylene liquid into the rubber mold;

allowing the polyethylene liquid to harden in the rubber mold;

removing the hardened polyethylene configuration from the rubber mold;

fabricating a second hardened polyethylene configuration via the rubber mold;

securing together cooperating edge portions of the polyethylene configurations via a plurality of aligned hinges with a central rod extending through the aligned hinges;

positioning the polyethylene configurations with a substantially vertical orientation;

anchoring upper portions of the vertically positioned configurations to a mounting surface; and

anchoring lower portions of the vertically positioned configurations to a mounting surface, whereby, the trellis device maintains a vertical position irrespective of wind speed and direction and the surface the trellis device is mounted upon.

### BRIEF DESCRIPTION OF THE DRAWINGS

The foregoing invention and its advantages may be readily appreciated from the following detailed description of the preferred embodiment, when read in conjunction with the accompanying drawings in which:

FIG. 1 is a front elevation view of a foldable trellis device depicting a butterfly in an open position in accordance with the present invention.

FIG. 1A is the front elevation view of FIG. 1, but with the central rod snugly inserted through a plurality of receiving conduits secured to edge portions of respective first and second portion of the foldable trellis device.

FIG. 2 is a back elevation view of the foldable trellis device of FIG. 1.

FIG. 3 is a front elevation view of a foldable trellis device depicting the butterfly trellis of FIG. 1 in a closed position in accordance with the present invention.

FIG. 4 is a back elevation view of the foldable trellis device of FIG. 3.

FIG. 5 is a front elevation view of a foldable trellis device depicting an angel in an open position in accordance with the present invention.

FIG. 6 is a back elevation view of the foldable trellis device of FIG. 5.

FIG. 7 is a front elevation view of a foldable trellis device depicting the angel trellis of FIG. 5 in a closed position in accordance with the present invention.

FIG. 8 is a back elevation view of the foldable trellis device of FIG. 7.

FIG. 9A is a top elevation view of the butterfly trellis device of FIG. 1A, but with a stabilizing member secured to first and second portions to form a substantially “T” configuration.

FIG. 9B is a top elevation view of the butterfly trellis device of FIG. 1A, but with a stabilizing member secured to first and second portions to form a substantially “Y” configuration.

FIG. 9C is a top elevation view of the butterfly trellis device of FIG. 1A, but with a stabilizing member secured to first and second portions to form a substantially star configuration.

### DESCRIPTION OF THE PREFERRED EMBODIMENT

Referring to the drawings, butterfly and angel foldable trellis devices in accordance with the present invention are denoted as numerals 10 and 11, respectively. The foldable trellis devices 10 and 11 include a predetermined trellis configuration having first and second symmetrical half portions 12 and 14 with identical dimensions and design features. The foldable trellis devices 10 and 11 further include pivoting connecting elements 16 to pivotally connected the two portions 12 and 14 to allow the two portions 12 and 14 to “close” such that front surfaces 18 and 20 of respective first and second portions 12 and 14 become engaged. Alternatively, the first and second portions 12 and 14 can be asymmetrically configured with different dimensions and design features.

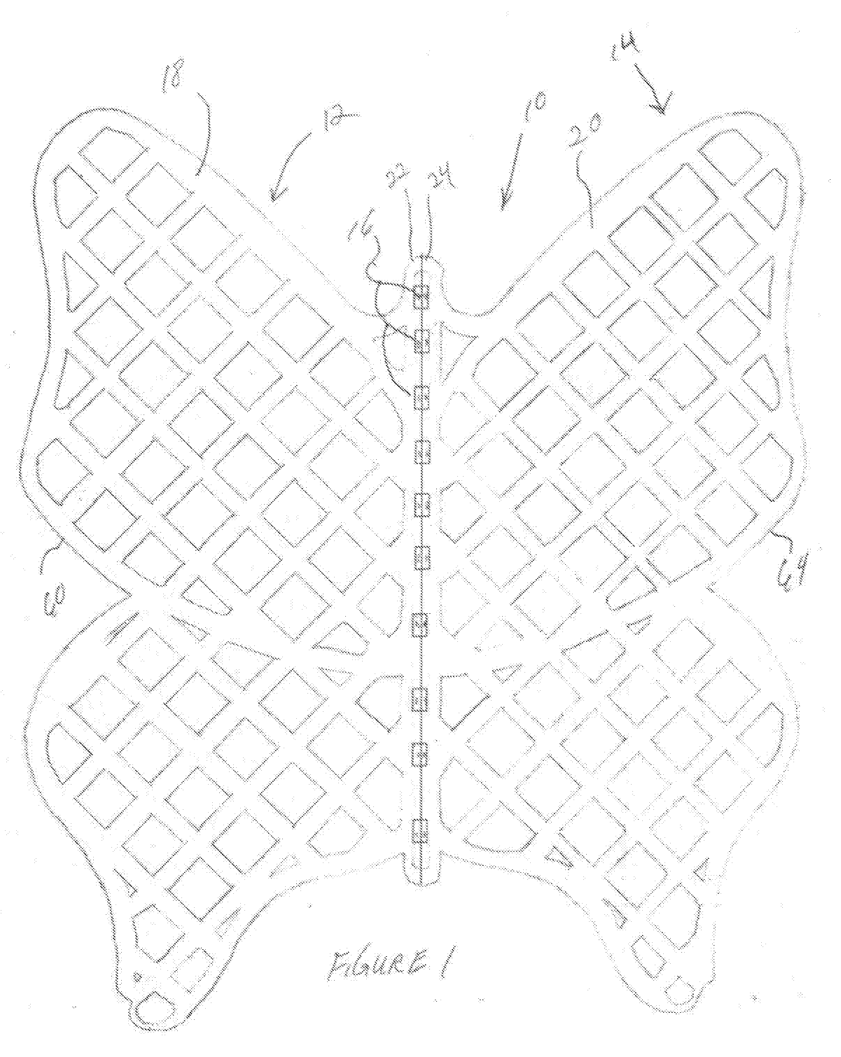

The preferred pivoting connecting elements (FIG. 1) are hinges 16 well known to those of ordinary skill, but a myriad of alternative pivoting elements can be used including, but not limited to a central rod 21 (FIG. 1A) snugly inserted through a plurality of receiving conduits 23 and 25 secured to respective edge portions 22 and 24 of respective first and second portion 12 and 14. The conduits 23 that are secured to each edge portion 22 and 24 are ultimately aligned such that one central rod 21 is able to be inserted through all conduits 23 irrespective of the conduits 23 being secured to the first or second portion 12 and 14 (or both 12 and 14), thereby pivotally joining together the first and second portions 12 and 14.

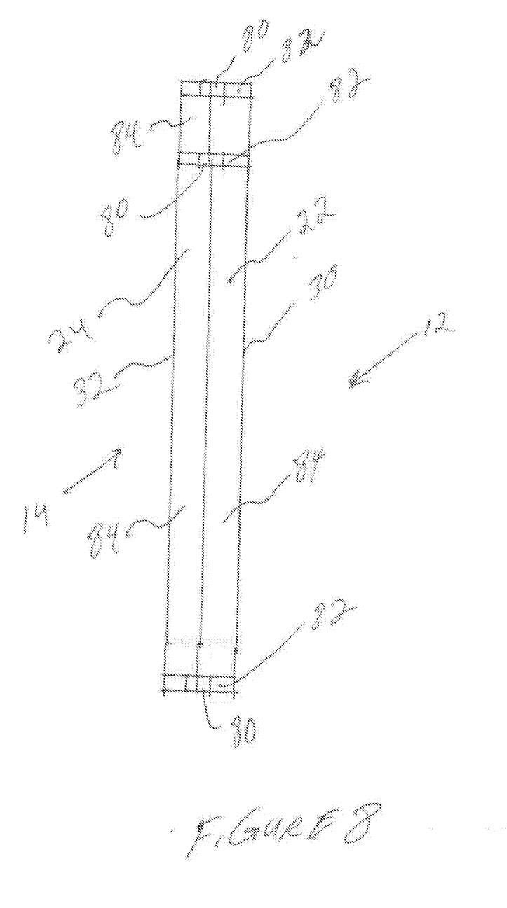

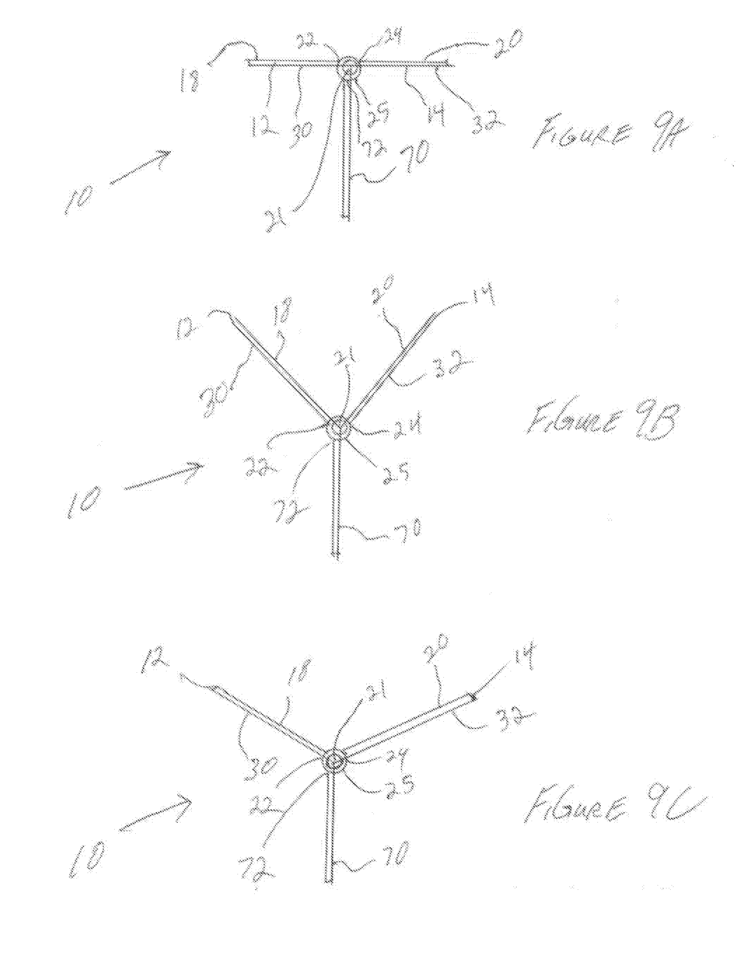

Although the trellis devices 10 and 11 depict a butterfly and an angel, configurations and corresponding dimensions for a foldable trellis device of the present invention are limited only by the users imagination and the size of the area upon which the respective foldable trellis device will ultimately be disposed. When selecting the configuration of the device, features of the selected configuration may require variations in the portions of the structure that form the device. For example, when taking front elevation views of the butterfly device 10 and the angel 11, it is observed that the butterfly 10 includes two independent first and second portions 12 and 14 that are hinged together. However, the angel device 11 includes gaps 80 in “unhinged” portions 82 of the angel device 11 configuration formed by peripheral strips 84 that promote apertures 38 to allow plants, flowers or light strings, for example, to attach to the angel device 11. The gaps 80 are vertically aligned with the hinges 16 to separate the unhinged portions 82 to allow the angel device 11 to be manually folded such that front surfaces 18 and 20 engage, or to position the angel device 11 similarly to the butterfly device 10 (when taking top elevation views) depicted in FIG. 9A, 9B or 9C.

The foldable trellis devices 10 and 11 can be manufactured from a myriad of materials, including but not limited to polymers (polyethylene and polypropylene being the preferred polymers), wood, steel, acrylic and similar rigid materials to maintain the configuration of the trellis device 10 and 11, irrespective of weather conditions and the weight of the object disposed upon the device 10 and 11. Alternatively, deformable materials such as copper and aluminum can be used when the user of the trellis device 10 and 11 needs to manually configure portions of the original device configuration to allow installation of the device 10 and 11 in a relatively small, irregularly configured area. Irrespective of the material of fabrication selected, the trellis devices 10 and 11 can be formed from crossing members 40 having a solid “rod” cross-sectional configuration or a tubular cross-sectional configuration with a central cavity extending longitudinally through each crossing member 40.

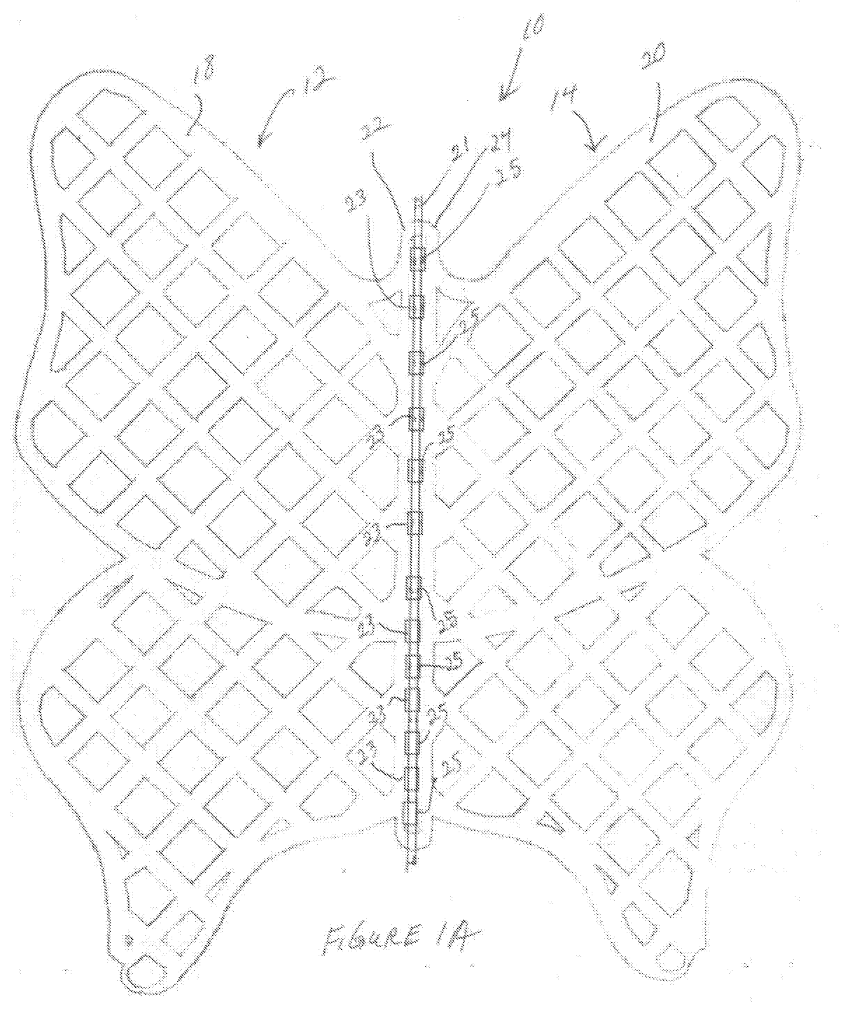

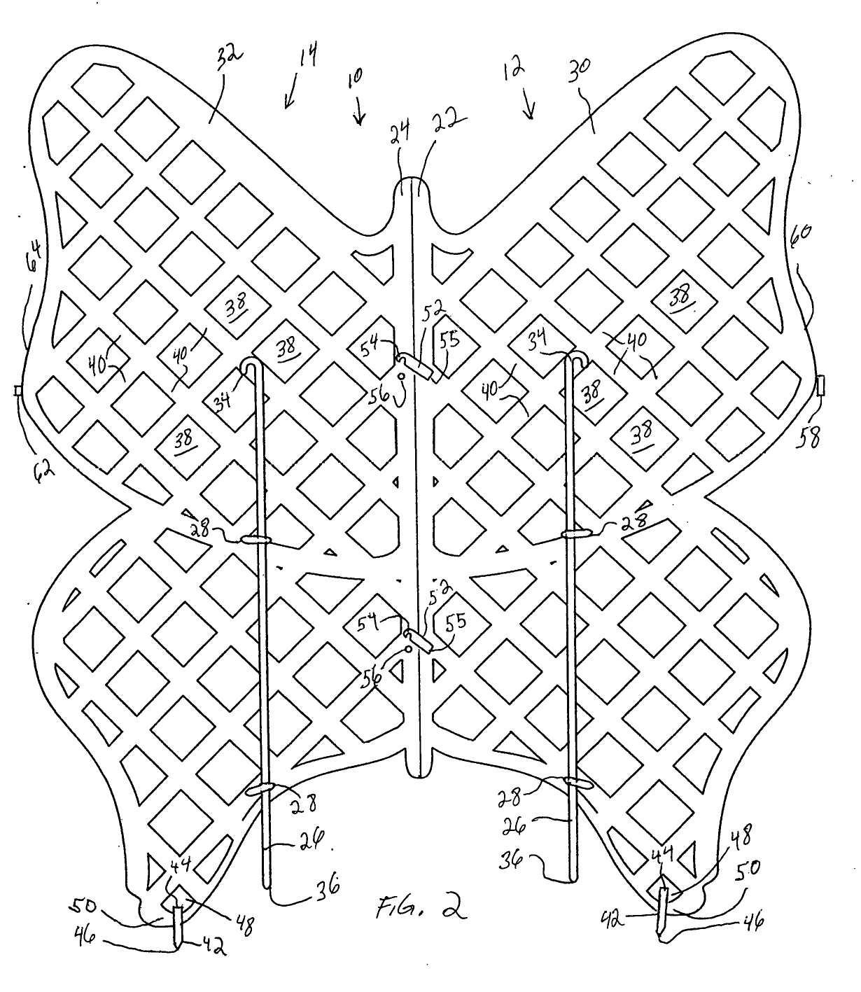

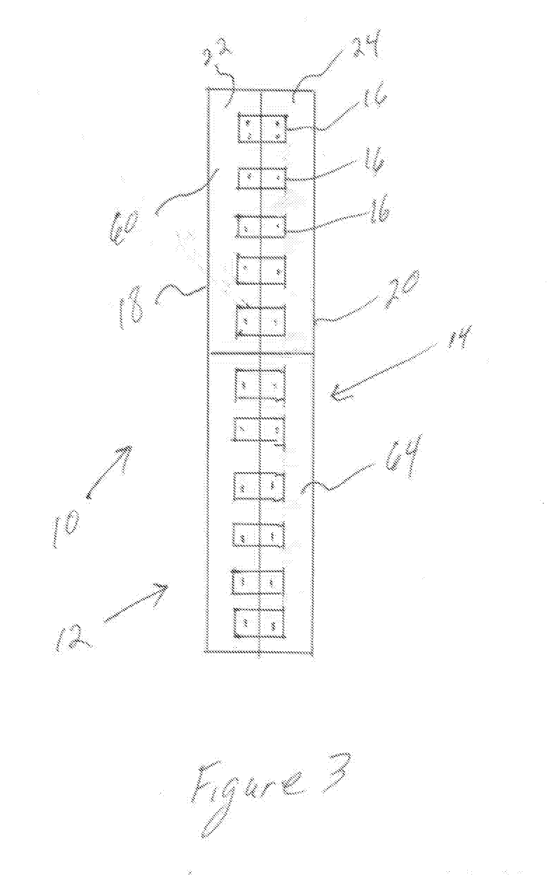

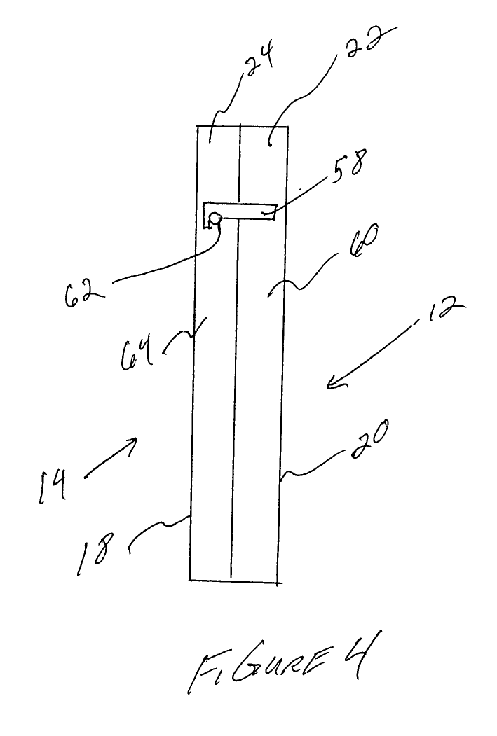

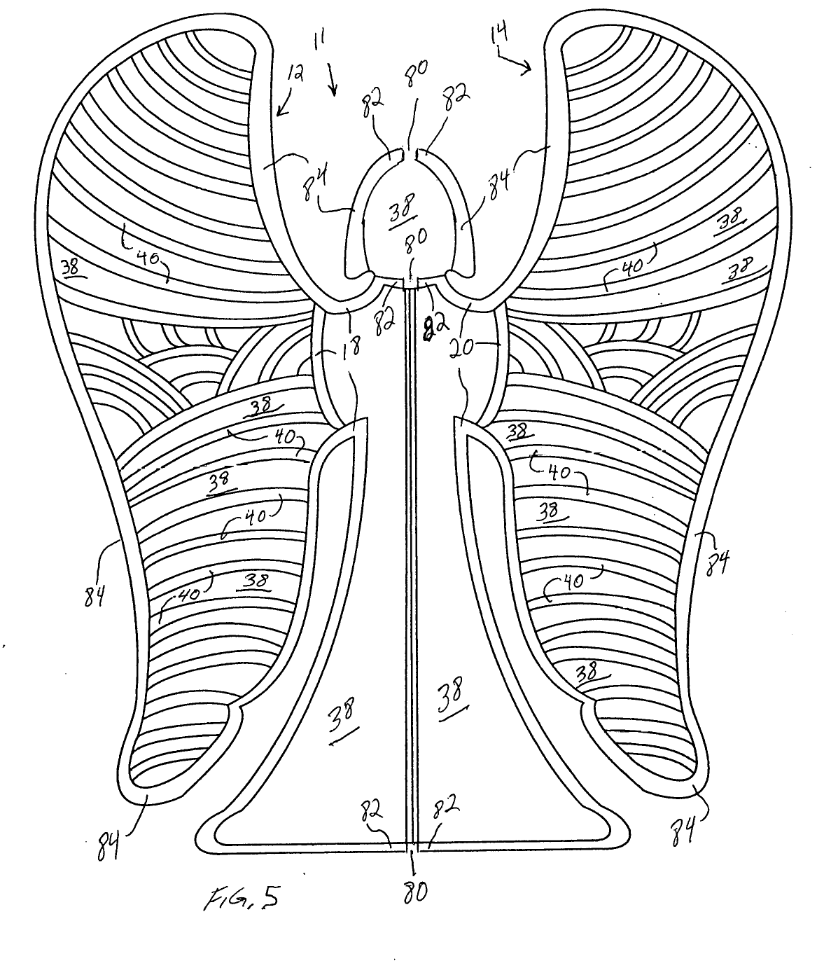

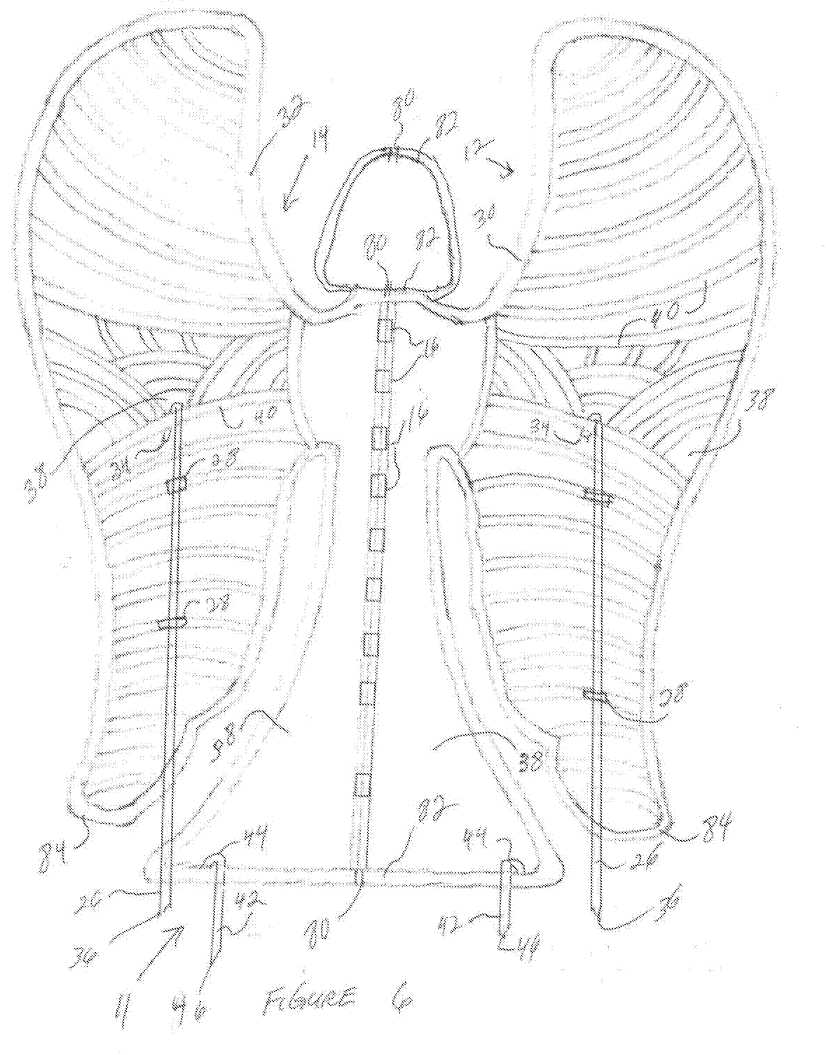

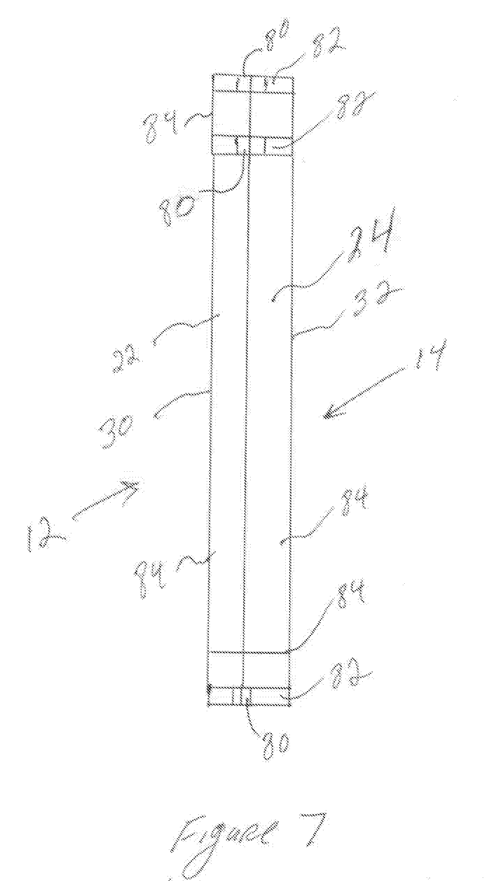

Referring now to FIGS. 1 and 2 for the butterfly foldable trellis device 10, the device 10 includes at least one steel anchoring rod 26 secured to each portion 12 and 14 via apertures in a plurality of metal receiving loops 28 that the anchoring rods 26 are slidably inserted through. Each loop 28 is attached via two opposing screws (not depicted) to preselected areas of a back surface 30 and 32 of respective first and second portions 12 and 14 of the device 10. The anchoring rods 26 include a hook configured upper end 34, a relatively pointed lower end 36 and longitudinal and diameter dimensions that cooperate to maintain the device 10 in a substantially vertical position irrespective of weather conditions object supported by the foldable trellis device 10. The hook configured upper end 34 and pointed lower end 36 promote the manually insertion into and removal from ground material upon which the device 10 is disposed. Further the hooked upper end 34 is ultimately disposed upon a bottom portion of an upper aperture 38 formed from crossing members 40, thereby securing anchor rods 26 to upper portions of each half portion 12 and 14. The anchor rods 26 cooperate with the loops 28 to stabilize upper and lower portions 38 and 50 of the device 10 to withstand relatively strong wind gusts engaging the device 10 when the device 10 is in an open position that separates the front surfaces 18 and 20 of the first and second portions 12 and 14 such that the front surfaces 18 and 20 are substantially co-planar or radially separated about one hundred and eighty degrees.

To further maintain and stabilize the vertical position, and to maintain and stabilize the horizontal position of the open foldable trellis device 10 and 11, multiple anchor clamps 42 having hooked upper ends 44 and pointed lower ends 46 (well known to those of ordinary skill in the art) are manually urged through bottom apertures 48 in the device 10, such that the hooked upper ends 44 of the anchor clamps 42 secure respective bottom portions 50 of the device 10 to a ground surface (not depicted) or a mounting bar when the lower ends 46 are threaded for rotational insertion into a cooperating threaded orifice in a mounting bar (not depicted).

The open position of the foldable trellis device 10 and 11 is maintained via multiple pivoting clamps 52 having a hook configured end 54 that is manually rotated about a pivot end 55 secured to an edge portion 22 of the back surface 30 of the first portion 12 of the device 10. The manually rotated hook configured end 54 ultimately and snugly engages a cooperating cylindrical collar fitting 56, whereupon, the open position of the foldable trellis device 10 is locked until the hook configured end 54 is manually rotated to disengage from the collar fitting 56, thus allowing the device 10 to be folded until the front surfaces 18 and 20 of the first and second portions 12 and 14 are engaged and secured together by a restraining hook 58 secured to an outer edge 60 of the first portion 12. The restraining hood 58 is manually rotated to engage a cylindrical collar fitting 62 secured to an outer edge 64 of the second portion 14, thereby securing the two first and second half portions 12 and 14 together and allowing the trellis device 10 to be readily stored until a time arrives for the device 10 to be reused. An alternative to the open planar position of the foldable trellis devices 10 and 11, is a substantially “V” shaped configuration (when taking a top view of the devices 10 and 11) formed via the first and second portions 12 and 14 being angularly separated substantially about ninety degrees.

Referring now to FIGS. 9A, 9B and 9C, top elevation views of FIG. 1 are depicted with a third “half portion” or stabilizing member 70 pivotally secured to the first and second portions 12 and 14 via a central rod 21 (see FIG. 1A) snugly inserted through a plurality of receiving conduits 23 secured to edge portions 22 and 24 of respective first and second portion 12 and 14, and an edge portion 72 of the stabilizing member 70. The pivotally joined first and second portions 12 and 14, and the stabilizing member 70 are manually positioned in a substantially “T” (FIG. 9A), “Y” (FIG. 9B) or star (FIG. 9C) configuration (when taking a top view). The T, Y or star configurations is selected by determining a wind speed and direction that is typical for the location where the trellis device is located. The greater the expected wind speed, the more the top view of the device 10 and 11 should depict a “Y” configuration and the less a T configuration. In extreme wind conditions that includes relatively strong wind gusts having varying directions, the first and second portions 12 and 14, and the stabilizing member 70 will be angularly displaced such that a star configuration having one hundred and twenty degrees (120 degrees) radially separating each adjacent pair of “half portions” (12, 14 and 70) is selected as depicted in FIG. 9C.

The preferred configuration of the stabilizing member 70 is identical to the configuration of the first and second portions 12 and 14, thereby providing a butterfly device 10 irrespective of the position of the person viewing the device 10. Although the preferred configuration of the stabilizing member 70 is identical to the configurations of the first and second portions 12 and 14, the design and dimensions of the first and second portions 12 and 14, and the design and dimensions of the stabilizing member 70 can be different for each one of the three half portions 12, 14 and 70.

In operation, a configuration for a trellis device 10 is selected that includes elements that cause the selected trellis configuration to maintain a vertical position irrespective of wind gusts common to the location of installation for the trellis. Next, a computer is programmed with the selected trellis configuration and corresponding trellis dimensions. The programmed computer then directs the cutting of a relatively rigid polymer block such as polyurethane to correspond to the selected configuration and dimensions (or scale) of the selected trellis. After the polyurethane block is cut to the specified configurations and dimensions, a silicon rubber mold is fabricated from the polyurethane block via methods well known to those or ordinary skill in the art. After removing the polyurethane block from the silicon rubber mold, a polyethylene or polypropylene liquid is inserted into the rubber mold, then allowing the liquid in the rubber mold to harden or become rigid. The hardened polymer liquid is then removed from the rubber mold and a second hardened polymer is then fabricated by using the same silicon rubber mold. The two half portions 12 and 14 are then secured together via a plurality of aligned pivoting connecting elements such as hinges 16 secured to edge portions 22 and 24 of the two half portions 12 and 14. Alternatively, a plurality of aligned conduits 23 through which a central rod 21 is removably inserted to pivotally join the two half portions 12 and 14 together. The joined half portions 12 and 14 that form the trellis configuration are then vertically positioned such that upper portions 38 of each half portion 12 and 14 are anchored to a mounting surface via anchor rods 26, and bottom portions 50 of the trellis device 10 are anchored to a mounting surface via anchor clamps 42, thereby maintaining the vertical position of the trellis device 10, irrespective of wind speed, wind direction and the surface the trellis device 10 is mounted upon.

1. A foldable hinged trellis device comprising:
a predetermined trellis configuration having at least two half portions;
means for pivotally joining cooperating edge portions of each of said two half portions; and
means for maintaining a selected vertical position of each of said two half portions after pivotally joining together said cooperating edge portions of said two half portions, said selected position being maintained irrespective of wind speed and wind direction.

2. The device of claim 1 wherein said two half portions are detachably joined together.

3. The device of claim 1 wherein said predetermined trellis configuration includes two symmetrical half portions.

4. The device of claim 1 wherein said predetermined trellis configuration includes two portions having different configurations.

5. The device in claim 1 wherein said means for pivotally joining cooperating edge portions of each of said two half portions includes a plurality of aligned hinges secured to front surfaces of each of said two half portions.

6. The device of claim 1 wherein said means for maintaining a selected vertical position for each of said two half portions includes at least two anchoring rods with at least one anchoring rod being vertically secured to a corresponding one of each of said two portions, said two anchoring rods each having a hooked upper end, a pointed lower end and a relatively long longitudinal dimension that allows said hooked upper ends to engage selected upper portions of said half portions, said two rods ultimately being urged into a ground portion.

7. The device of claim 1 wherein said means for maintaining a selected vertical position for each of said two half portions includes at least two anchor clamps with at least one anchor clamp engaging a bottom portion of each of said two half portions, said two anchor clamps ultimately being urged into a ground portion.

8. The device of claim 1 wherein said configuration includes two half portions secured together such that a substantially “V” configuration is formed when taking a top view of said device.

9. The device of claim 1 wherein said two half portions includes means for maintaining said two half portions in a substantially planar orientation relative to each other when said two half portions are vertically secured to a mounting surface, said means for maintaining said two half portions in a planar orientation including at least one pivot clamp having a pivot end pivotally secured to a back surface of an edge portion of a first half portion; said pivot clamp having a hook end that pivotally connects to a collar fitting secured to a back surface of a second edge portion of a second half portion, thereby enabling said hook end of said pivot clamp to pivot and engage said collar fitting, resulting in said first and second half portions being locked in a substantially planar orientation to prevent said two half portions from folding via said aligned hinges when said front surface of said trellis device is exposed to relative strong winds.

10. The device of claim 8 wherein said two half portions are radially separated substantially about 90 degrees.

11. A foldable hinged trellis device comprising:
a predetermined trellis configuration having at least three substantially similarly configured portions;
means for pivotally joining cooperating edge portions of each of said three substantially similarly configured portions; and
means for maintaining a selected vertical position for each of said three configured portions after pivotally joining together said cooperating edge portions of said three configured portions, said selected vertical position being maintained irrespective of wind speed and wind direction.

12. The device of claim 11 wherein said predetermined trellis configuration includes at least three portions joined together to form a central axis.

13. The device of claim 11 wherein said predetermined trellis configuration includes at least three portions joined together to form a “T” configuration when taking a top view of said device.

14. The device of claim 11 wherein said predetermined trellis configuration includes a least three portions joined together to form a star configuration when taking a top view of said device.

15. The device of claim 11 wherein said configuration includes three portions secured together such that a relatively “Y” configuration is formed when taking a top view of said device.

16. The device of claim 14 wherein each one of said three portions is radially separated from two adjacent portions substantially about 120 degrees.

17. A method for fabricating a wind resistant trellis, said method comprising the steps of:
selecting a configuration for said trellis;
programming said selected configuration into a computer;
directing said programmed computer to cut, to a preselected scale, said selected configuration from a relatively rigid polymer;
fabricating a rubber mold from said polymer configuration;
inserting polyethylene liquid into said rubber mold;
allowing said polyethylene liquid to harden in said rubber mold;
removing said hardened polyethylene configuration from said rubber mold;
fabricating a second hardened polyethylene configuration via said rubber mold;
securing together cooperating edge portions of said polyethylene configurations via a plurality of aligned hinges;
positioning said polyethylene configurations with a substantially vertical orientation;
anchoring upper portions of said vertically positioned configurations to a mounting surface; and
anchoring lower portions of said vertically positioned configurations to a mounting surface, whereby, said trellis device maintains a vertical position irrespective of wind speed and direction and the surface said trellis device is mounted upon.

18. The method of fabricating a trellis device claim 17 wherein said step of securing together cooperating edge portions of said polyethylene configurations includes the step of securing said polyethylene configurations together after folding said trellis device in half via said plurality of aligned hinges.

19. The method of claim 17 wherein said step of anchoring upper portions of said vertically positioned configurations to a mounting surface includes the step of providing at least one anchoring rod for each of said two configurations, said two anchoring rods each having a hooked upper end, a pointed lower end and a relatively long longitudinal dimension that allows said hooked upper ends to engage selected upper portions of said configurations, said two rods ultimately being urged into a mounting surface.

20. The method of claim 17 wherein said step of anchoring a lower portions of said vertically positioned configurations to a mounting surface includes the step of providing at least two anchor clamps with at least one anchor clamp engaging a bottom portion of each of said configurations, said anchor clamps ultimately being urged into a mounting surface.
